(19) United States
(12) Patent Application Publication
(10) Pub. No.: US 2010/0115159 A1
(43) Pub. Date: May 6, 2010

(54) KEYBOARD SHORTCUT SOFTWARE UTILITY

(75) Inventor: Garb B. Cookson, Chatsworth, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Bella Corporation

(21) Appl. No.: 12/265,635

(22) Filed: Nov. 5, 2008

(51) Int. Cl. G06F 3/00

(52) U.S. Cl. 710/67

(57) ABSTRACT

A method and system for accessing one or more functions corresponding to one or more applications is provided. An active application is determined. Subsequently, a set of functions corresponding to the active application is identified. A set of keys corresponding to the set of functions is displayed on a display panel. One or more inputs are received, based on activation of at least one key. At least one function corresponding to the at least one key is determined and performed.

### BACKGROUND

The present invention relates, in general, to keyboard shortcuts. More specifically, the present invention relates to a method and system for accessing one or more functions corresponding to one or more applications.

A typical hardware keyboard includes a set of input keys, such as typewriter keys, function keys, enter keys, system keys, and the like. Apart from the hardware keyboards, various virtual keyboards have been employed for display on a display screen however they do not effectively address using shortcuts.

Various functions corresponding to a particular application may be accessed through shortcut keys. These shortcut keys may, for example, include direct keystrokes or combination keystrokes. As there may be over forty direct keystrokes associated with an application, remembering which keystroke is associated with which shortcut can be nearly impossible, especially with new users of the application.

Shortcut keyboards for specific applications have been employed. These shortcut keyboards provide keycap icons representing shortcut keys for accessing functions corresponding to a specific application. These keycap icons sometimes use color and function coding.

However, existing shortcut keyboards have certain limitations. If a user uses the application that relates to the shortcut keyboard occasionally, he/she has to still see the color and function coding on the keycaps while he/she is using any other application. This may be very confusing to the user. In addition, a single shortcut keyboard has the correct shortcuts for only one application, and cannot be customized for other applications. Therefore, a user wanting to use several applications, each with their own unique shortcuts, may not find such a shortcut keyboard useful. Further, the top of a keycap can become overly busy and difficult to read, due to icons, and color and function coding. This, in turn, negates the time-saving purpose of such a keyboard. Moreover, only direct keystrokes can be displayed on the keycaps. Therefore, additional functions that are usually available using modifier keys, such as Alt and Ctrl for Windows Operating System (OS), and Option and Command for Mac OS, cannot be displayed on the keycaps. In addition, in certain applications, various modes are available, where each mode has a different set of keyboard shortcuts. This situation cannot be addressed as the keycaps cannot be changed. For example, in certain video editing applications, a titling mode and an effects mode are provided, where each mode has its own set of keystrokes. Moreover, these shortcut keyboards may not be available for all languages of keyboards available, such as AZERT or UK keyboards. Furthermore, certain applications allow the user to customize or re-map the shortcuts. As the existing shortcut keyboards are hardware based, the user cannot customize or re-map the shortcuts on such shortcut keyboards. In addition, such shortcut keyboards are expensive, and therefore, are not practical for most users.

In light of the foregoing discussion, there is a need for a method and system for accessing one or functions corresponding to one or more applications that supports various applications and languages, allows user-customization and multi-user settings, and is easy to use.

### SUMMARY

An object of the present invention is to provide a method and system for accessing one or more functions corresponding to one or more applications.

Another object of the present invention is to provide a method and system for accessing one or more functions corresponding to one or more applications and supporting multiple languages.

Yet another object of the present invention is to provide a method and system for accessing one or more functions corresponding to one or more applications and allowing user-customization and multi-user settings.

Still another object of the present invention is to provide a method and system for accessing one or more functions corresponding to one or more applications that is easy to use and economical.

Embodiments of the present invention provide a method and system for accessing one or more functions corresponding to one or more applications. An active application from a set of applications is determined. A set of functions from the functions corresponding to the active application is also determined. Thereafter, a set of keys corresponding to the set of functions is displayed on a display panel. One or more inputs are received, based on activation of at least one key from the set of keys. At least one function from the set of functions is determined corresponding to the activated key. The function corresponding to the activated key is then performed.

In an embodiment of the present invention, the display panel is displayed in a predefined layout. The predefined layout may, for example, be a keyboard layout, a list layout or a tabular layout. In another embodiment of the present invention, the display panel is displayed in a layout configurable by the user. In an embodiment of the present invention, one or more display parameters of the display panel are configurable by the user. Examples of the display parameters include, but are not limited to, color coding, function coding, icon shapes, icon sizes, fonts, font sizes, key identifiers, grouping, magnetic alignment, background, shadow, opacity, orientation, screen position, appearance time, hiding/unhiding marked shortcuts and animation. One or more configurations of the display parameters may then be stored. In this way, the method and system of the present invention allow user-customization and multi-user settings.

When the user switches from a first active application to a second active application, it is determined that the second active application is a new active application on which the user is currently working. Accordingly, a new set of functions corresponding to the second active application is identified. Consequently, the display panel automatically displays a new set of keys corresponding to the new set of functions. This makes the method and system easy to use. As described above, the method and system support various applications, and provide mode-specific display of the display panel.

The method and system are software-based, and therefore, can be easily implemented in various languages.

### BRIEF DESCRIPTION OF THE DRAWINGS

FIG. 1 illustrates an environment wherein various embodiments of the present invention may be practiced;

FIG. 2 is a block diagram illustrating a system for accessing one or more functions corresponding to one or more applications, in accordance with an embodiment of the present invention;

FIG. 3 is a block diagram illustrating a system for accessing one or more functions corresponding to one or more applications, in accordance with another embodiment of the present invention;

FIG. 4 is a flow diagram illustrating a method for accessing one or more functions corresponding to one or more applications, in accordance with an embodiment of the present invention;

FIG. 5 is a flow diagram illustrating a method for accessing one or more functions corresponding to one or more applications, in accordance with another embodiment of the present invention;

FIG. 6 illustrates a keyboard layout, in accordance with an embodiment of the present invention;

FIG. 7 illustrates a list layout, in accordance with an embodiment of the present invention; and

FIG. 8 illustrates a tabular layout, in accordance with an embodiment of the present invention.

### DETAILED DESCRIPTION OF THE INVENTION

Embodiments of the present invention provide a method, system and computer program product for accessing one or more functions corresponding to one or more applications. In the description herein for embodiments of the present invention, numerous specific details are provided, such as examples of components and/or mechanisms, to provide a thorough understanding of embodiments of the present invention. One skilled in the relevant art will recognize, however, that an embodiment of the present invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of the embodiments of the present invention.

An active application is determined. Subsequently, a set of functions corresponding to the active application is determined. Thereafter, a set of keys corresponding to this set of functions is displayed on a display panel. One or more inputs are received, based on activation of at least one key by a user. At least one function corresponding to the at least one key is determined and performed.

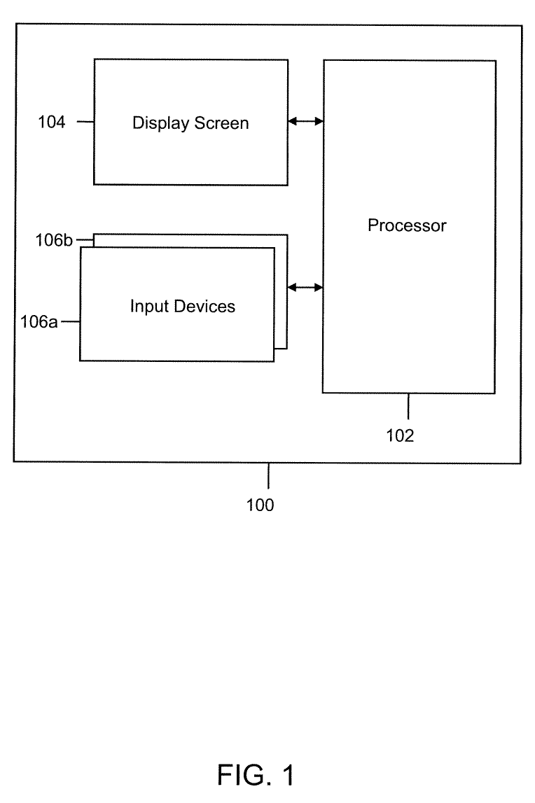

FIG. 1 illustrates an environment 100 wherein various embodiments of the present invention may be practiced. Environment 100 includes a processor 102, a display screen 104, an input device 106a, and an input device 106b.

A user runs one or more applications (not shown in the figure) on processor 102. Display screen 104 is operatively coupled to processor 102, and displays these applications. Display screen 104 displays a set of keys for accessing a set of functions corresponding to an active application, in accordance with an embodiment of the present invention.

Input devices 106a and 106b are operatively coupled to processor 102. The user may provide one or more inputs by activating at least one key using at least one of input devices 106a and 106b. Subsequently, at least one function from the set of functions corresponding to the at least one key is determined and performed. Examples of input devices 106a and 106b include, but are not limited to, a mouse, a touch-sensitive screen, a keyboard, a trackball, a touchpad, a joystick, a pointing stick, and a graphics tablet with a pen.

Examples of environment 100 include, but are not limited to, personal computers, laptops, mobile phones, Personal Digital Assistants (PDAs), Global Positioning System (GPS) Navigation Devices, Mobile Internet Devices (e.g., communicators), Automatic Teller Machines (ATMs), Arcade Games, and Digital Diaries. Examples of display screen 104 include, but are not limited to, Cathode Ray Tube (CRT) monitors, Liquid Crystal Displays (LCDs), Plasma Display Panels (PDPs) and any projected display.

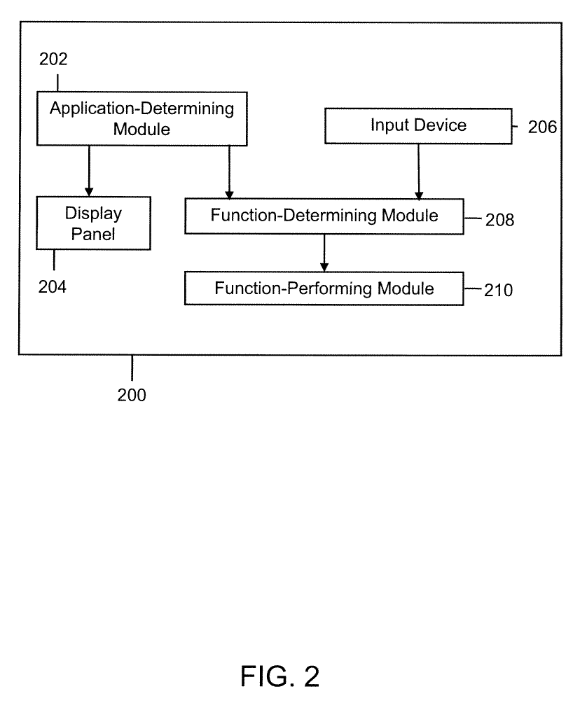

FIG. 2 is a block diagram illustrating a system 200 for accessing one or more functions corresponding to one or more applications, in accordance with an embodiment of the present invention. System 200 includes an application-determining module 202, a display panel 204, an input device 206, a function-determining module 208, and a function-performing module 210.

Application-determining module 202 determines an active application from the applications. The active application refers to the application on which the user is currently working. Examples of the applications include, but are not limited to, operating systems, such as Microsoft® Windows XP and Microsoft® Windows Vista, and software applications, such as Microsoft® Office, Adobe® Photoshop, Adobe® Indesign, Adobe® Illustrator, Adobe® Reader, AutoCAD®, other CAD applications, Quickbooks®, gaming applications, audio/video editing applications and design applications. A set of functions corresponding to the active application is identified by application-determining module 202, in accordance with an embodiment of the present invention. Consider, for example, that Microsoft® Word application is the active application. In such a case, the set of functions may, for example, include italicizing and underlining text.

Display panel 204 displays a set of keys corresponding to the set of functions. The set of keys may, for example, include typewriter keys, system keys, function keys, cursor-control keys, enter keys, user-customizable keys, and shortcut keys. Examples of the typewriter keys include, but are not limited to, alphanumeric keys, special character keys, shift keys, control (Ctrl) keys, alt keys, tab key and caps lock key. An example of the system keys is window key. The user may also choose to view a part of display panel 204. Continuing from the above example, the set of keys may include keys corresponding to italicizing and underlining text.

Input device 206 receives one or more inputs from the user. The inputs are based on activation of at least one key by the user. Examples of input device 206 include, but are not limited to, a mouse, a touch-sensitive screen, a keyboard, a trackball, a touchpad, a joystick, a pointing stick, and a graphics tablet with a pen. The user may, for example, activate the key by selecting it from display panel 204. Alternatively, the user may activate the key by pressing it on a keyboard.

Function-determining module 208 determines at least one function corresponding to the activated key. Consider, for example, that the user is currently working on a multimedia application, and has activated the key ‘/’. Consequently, function-determining module 208 determines that the function of marking-in a point in multimedia content running on the multimedia application corresponds to the key ‘/’.

Function-performing module 210 performs the function corresponding to the activated key. Continuing from the above example, the point in the multimedia content is marked-in.

It should be noted that the functionalities of various components of system 200 may be combined or divided among various devices. An implementation of these components may be stored on or transmitted across one or more forms of computer program products.

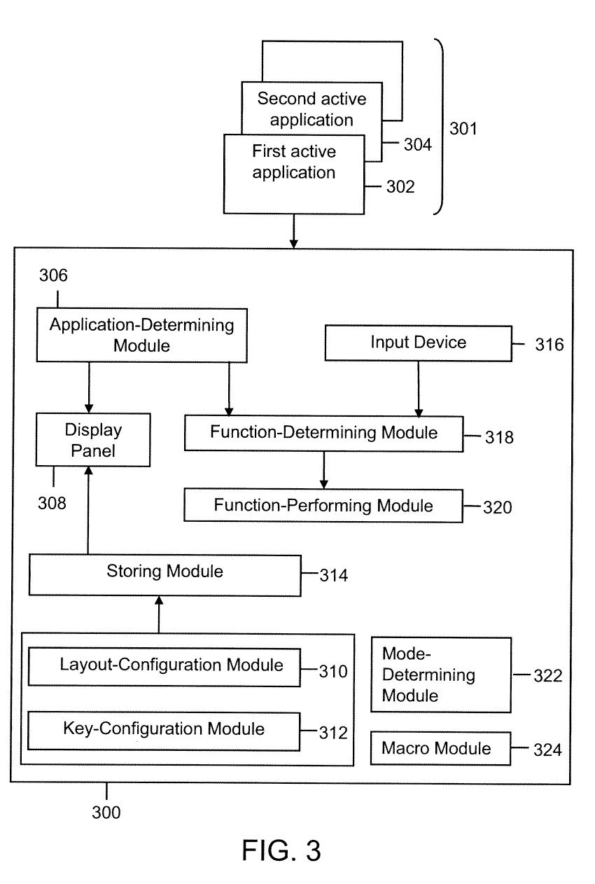

FIG. 3 is a block diagram illustrating a system 300 for accessing one or more functions corresponding to one or more applications 301, in accordance with another embodiment of the present invention. Applications 301, such as a first active application 302 and a second active application 304, run on system 300. System 300 includes an application-determining module 306, a display panel 308, a layout-configuration module 310, a key-configuration module 312, a storing module 314, an input device 316, a function-determining module 318, a function-performing module 320, a mode-determining module 322 and a macro module 324.

Application-determining module 306 determines that first active application 302 is an active application on which the user is currently working. A set of functions corresponding to first active application 302 is identified by application-determining module 306, in accordance with an embodiment of the present invention. Consider, for example, that first active application 302 is Adobe® Photoshop application. In such a case, the set of functions may, for example, include cropping and moving images.

Display panel 308 displays a set of keys corresponding to the set of functions. Continuing from the above example, the set of keys may include keys corresponding to cropping and moving images.

When the user switches from first active application 302 to second active application 304, application-determining module 306 determines that second active application 304 is a new active application on which the user is currently working. Application-determining module 306 also determines a new set of functions corresponding to second active application 304. Consequently, display panel 308 displays a new set of keys corresponding to the new set of functions. Consider, for example, that second active application 304 is Adobe® Reader. In such a case, the new set of functions may, for example, include zooming and view-rotating pages. Accordingly, the new set of keys corresponds to zooming and view-rotating pages.

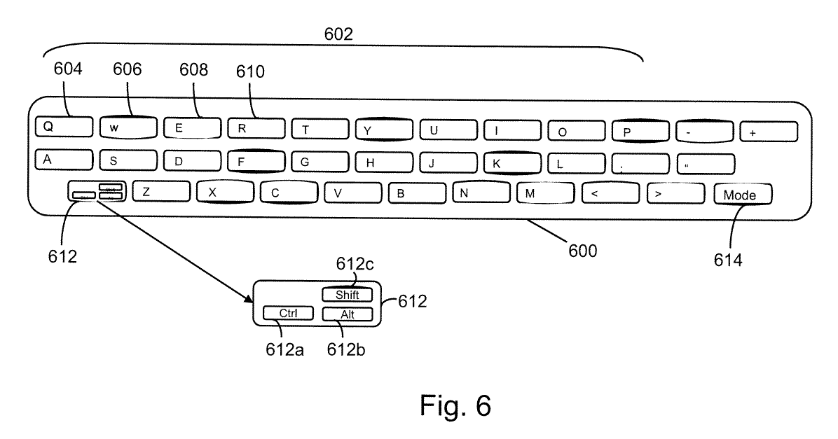

Layout-configuration module 310 configures the layout of display panel 308, i.e., the layout of the set of keys displayed on display panel 308. In an embodiment of the present invention, display panel 308 is displayed in a predefined layout. The predefined layout may, for example, include a list layout, a tabular layout, or a keyboard layout. In another embodiment of the present invention, the layout of display panel 308 is configurable by the user. The user may customize the predefined layout as per his/her requirements. The user may then save his/her customized layout for future use. Details of various predefined layouts have been provided in conjunction with FIGS. 6, 7 and 8.

Key-configuration module 312 configures one or more display parameters of the set of keys displayed on display panel 308. In an embodiment of the present invention, the display parameters are predefined in system 300. In another embodiment of the present invention, the display parameters are configurable by the user. For example, the user may hide certain keys as per his/her requirements. This may be accomplished by marking keys that the user wants to hide or unhide. In addition, the function of certain keys may be redefined by the user. For example, the key ‘/’, used in a multimedia application as a mark-in key to mark-in a point in multimedia content running on the multimedia application, may be redefined by the user to mark-in and split the multimedia content simultaneously. Examples of the display parameters include, but are not limited to, color coding, function coding, icon shapes, icon sizes, fonts, font sizes, key identifiers, grouping, magnetic alignment, background, shadow, opacity, orientation, screen position, appearance time, hiding/unhiding marked shortcuts and animation.

Color coding refers to coding the keys on the basis of a particular function, by using a color code. For example, the user may use ‘pink’ for coding shortcut keys, ‘yellow’ for coding numeric keys, and so on.

Function coding refers to names and descriptions of one or more functions performed by actuating a particular key. The function names and descriptions may, for example, be shown as a hover text, a list, or a table. For example, the function names and descriptions may be represented by text labeled on icons representing the keys on display panel 308.

In an embodiment of the present invention, the keys are represented by icons on display panel 308. Icon sizes and icon shapes refer to various sizes and shapes of icons that may be selected by the user.

Fonts and font sizes refer to various styles and sizes of fonts that may be selected by the user. A plurality of fonts may be provided to the user. Alternatively, the user may add and use fonts of his/her choice.

Key identifier may, for example, refer to alphabets, numbers and special characters labeled on the keys. For example, the alphanumeric key ‘A’ may be represented by an icon labeled with the alphabet ‘A’ in display panel 308.

Grouping refers to grouping related keys together on display panel 308. The grouping may, for example, be based on functional relationships of the keys. The grouping may also be based on direct keystrokes or combination keystrokes. For example, the combination keystrokes ‘Ctrl+B’, ‘Ctrl+U’ and ‘Ctrl+/’ may be grouped together in Microsoft® Word application. Alternatively, the user may choose to group keys by color. For example, if the user chooses to group by color, keys coded in the same color are grouped together. In addition, the user may group keys as per his/her requirements.

Magnetic alignment refers to ‘snapping’ of keys to a location on an active window on which an active application is displayed, or on display screen 104. The keys may, for example, be snapped to the inside or outside of the active window. Alternatively, the keys may be snapped to at least one edge or corner of display screen 104.

Background of display panel 308 refers to setting a color or a graphic image as the background of display panel 308.

Shadow refers to switching-on or switching-off shadowed appearance of keys and/or display panel 308, depending on the user's choice.

Opacity refers to regulating the level of transparency of icons, background, key identifiers, function names and descriptions, display panel 308, or a combination thereof.

Orientation refers to the orientation of display panel 308 on display screen 104. For example, display panel 308 may be horizontally oriented above or below the active window. Alternatively, display panel 308 may be vertically oriented beside the active window.

Screen position refers to the position of display panel 308 on display screen 104. In an example, display panel 308 may float freely outside the active window. In another example, display panel 308 may occupy free space around the active window automatically. In yet another example, display panel 308 may be positioned manually by the user. In addition, the position of display panel 308 may be changed, based on a usage area of input device 316 on display screen 104. For example, display panel 308 may be moved away from the usage area of input device 316. In such a case, the user may also set a distance at which display panel 308 is to be moved away from the usage area of input device 316.

Appearance time refers to the time for which display panel 308 is displayed on display screen 104. In an example, display panel 308 may be always displayed on display screen 104. In such a case, display panel 308 may be displayed always on top. In another example, display panel 308 may be displayed for a predefined time period on display screen 104. The predefined time period may be either system-defined or user-defined. In yet another example, the display of display panel 308 may be toggled on or off.

Animation refers to an animation style in which at least a portion of display panel 308 is displayed on display screen 104. In accordance with an embodiment of the present invention, display panel 308 is displayed in an animation style when at least one key is selected by the user. The display parameter of animation may be switched on/off by the user. In addition, the animation style may be selected by the user. Examples of animation styles include, but are not limited to, sliding-in/sliding-out, fading-in/fading-out, highlighting/unhighlighting. The animation style may, for example, also include changing the look and feel of display panel 308, also referred as the skin of display panel 308. For this purpose, various skin templates may be stored in system 300 by default or by the user.

In addition to the above-mentioned display parameters, key-configuration module 312 may configure additional display parameters of display panel 308. For example, display panel 308 or a part of display panel 308 may be switched on/off on actuation of a hot key on a keyboard or pointing a hot corner on display screen 104 by a pointing device.

Further, display panel 308 may display combination keystrokes with ‘Alt’ and/or ‘Ctrl’ key for additional functions corresponding to the active application. For example, combination keystrokes with the key ‘Alt’ may be displayed when the key ‘Alt’ is activated. Similarly, combination keystrokes with the key ‘Ctrl’ may be displayed when the key ‘Ctrl’ is activated. Combination keystrokes with the keys ‘Alt’ and ‘Ctrl’ may be displayed when the keys ‘Alt’ and ‘Ctrl’ are activated simultaneously.

Further, predefined words may be displayed in display panel 308, instead of symbols. For example, the word ‘EUR’ may be displayed instead of the symbol ‘£’, and the word ‘USD’ may be displayed instead of the symbol ‘$’.

Storing module 314 stores the display parameters of the set of keys of display panel 308. In an embodiment of the present invention, storing module 314 stores system-defined values of the display parameters by default. In another embodiment of the present invention, storing module 314 stores one or more configurations of the display parameters selected by the user. Storing module 314 stores the layout of display panel 308 configured by the user, in accordance with an embodiment of the present invention. The layout of display panel 308 and the configurations of the display parameters may, for example, be stored as settings of the user.

In an embodiment of the present invention, a particular configuration of the display parameters may be applied to each of applications 301. In another embodiment of the present invention, different applications 301 may have different preferences for the configurations. Consider, for example, that Microsoft® Word is the active application. In such a case, display panel 308 may be displayed in accordance with a configuration specific to Microsoft® Word.

In accordance with an embodiment of the present invention, system 300 allows multi-user settings. For example, a first user may configure a first layout of display panel 308 and a first configuration of the display parameters, as per his/her requirements. The first layout and the first configuration may then be stored as settings of the first user. Similarly, a second user may configure a second layout of display panel 308 and a second configuration of the display parameters, as per his/her requirements. The second layout and the second configuration may then be stored as settings of the second user. When the first user logs in, the settings corresponding to the first user are applied to system 300. Similarly, when the second user logs in, the settings corresponding to the second user are applied to system 300.

Examples of storing module 314 include, but are not limited to, memory, hard disks, Compact Disks (CDs), Digital Versatile Disks (DVDs), Floppy Disks and memory cards.

Input device 316 receives one or more inputs from the user. The inputs are based on activation of at least one key by the user. Examples of input device 316 include, but are not limited to, a mouse, a touch-sensitive screen, a keyboard, a trackball, a touchpad, a joystick, a pointing stick, and a graphics tablet with a pen. The user may, for example, activate the key by selecting it from display panel 308. Alternatively, the user may activate the key by pressing it on a keyboard.

Function-determining module 318 determines at least one function corresponding to the activated key. Consequently, function-performing module 320 performs the function corresponding to the activated key.

Mode-determining module 322 determines a mode in which the user is currently working on the active application. Consequently, display panel 308 displays the set of keys to match a new set of functions corresponding to that mode. For example, display panel 308 may be displayed in accordance with a default mode of the active application. The user may switch to a different mode of the active application. Mode-determining module 322 determines the mode to which the user switched, and display panel 308 displays the set of keys to match a different set of functions corresponding to the mode to which the user switched.

Macro module 324 executes one or more macros corresponding to the active application. A macro is defined as a series of commands grouped together as a single command, which when executed accomplish a task automatically. For example, a macro corresponding to Microsoft® Word application may include inserting a table with a specific size and borders, and with a specific number of rows and columns. In an embodiment of the present invention, the macros are configured by the user. For example, the user may configure a macro corresponding to Microsoft® Word application by recording the macro to perform multiple tasks. The user may also configure the macro by using Microsoft® Visual Basic Editor. The user may then assign the macro to a toolbar button, a menu, or a key.

In an embodiment of the present invention, system 300 supports different natural languages. A current natural language of display panel 308 may be switched to a different natural language, as per the user's requirement. Examples of the natural languages include, but are not limited to, Albanian, Belgian, Canadian, Chinese ChaJei, Croatian, Czech, Danish, Dutch, English UK, English US, Estonian, Finnish, French, German, Greek, Hebrew, Hungarian, Icelandic, Irish, Italian, Korean, Latin American, Latvian, Norwegian, Polish, Portuguese, Romanian, Russian, Slovak, Slovenian, Spanish, Swedish and Turkish.

In an embodiment of the present invention, system 300 supports simultaneous display of keys in multiple natural languages. For example, translation applications interact with the user via different character sets (e.g., English and Russian).

It should be noted that the functionalities of various components of system 300 may be combined or divided among various devices. An implementation of these components may be stored on or transmitted across one or more forms of computer program products.

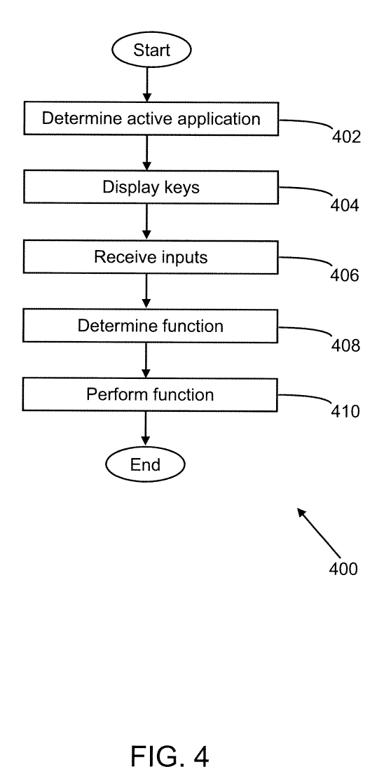

FIG. 4 is a flow diagram illustrating a method for accessing one or more functions corresponding to one or more applications, in accordance with an embodiment of the present invention. The method is illustrated as a collection of steps in a logical flow diagram, which represents a sequence of steps that can be implemented in hardware, software, or a combination thereof. In the context of software, the steps represent computer instructions that, when executed by one or more processors, perform the recited steps.

At step 402, an active application from the applications is determined. The active application refers to the application on which the user is currently working. In accordance with an embodiment of the present invention, step 402 is performed by application-determining module 202 in FIG. 2. A set of functions corresponding to the active application is also identified. Consider, for example, that Microsoft® Word application is the active application. In such a case, the set of functions may, for example, include italicizing and underlining text. The set of functions may also include one or more macros corresponding to the active application.

At step 404, a set of keys corresponding to the set of functions is displayed. In accordance with an embodiment of the present invention, step 404 is performed by display panel 204. In an embodiment of the present invention, the set of keys is displayed in a predefined layout. The predefined layout may, for example, be a keyboard layout, a list layout or a tabular layout. In another embodiment of the present invention, the set of keys is displayed in a layout configurable by the user. The user may also choose to view a part of display panel 204. Continuing from the above example, the set of keys may include keys corresponding to italicizing and underlining text.

In an embodiment of the present invention, one or more display parameters of the set of keys are configurable by the user. Examples of the display parameters include, but are not limited to, color coding, function coding, icon shapes, icon sizes, fonts, font sizes, key identifiers, grouping, magnetic alignment, background, shadow, opacity, orientation, screen position, appearance time, hiding/unhiding marked shortcuts and animation.

At step 406, one or more inputs are received from the user. The inputs are based on activation of at least one key from the set of keys. In accordance with an embodiment of the present invention, step 406 is performed by input device 206.

At step 408, at least one function from the set of functions is determined corresponding to the activated key. In accordance with an embodiment of the present invention, step 408 is performed by function-determining module 208.

At step 410, the function corresponding to the activated key is performed. In accordance with an embodiment of the present invention, step 410 is performed by function-performing module 210.

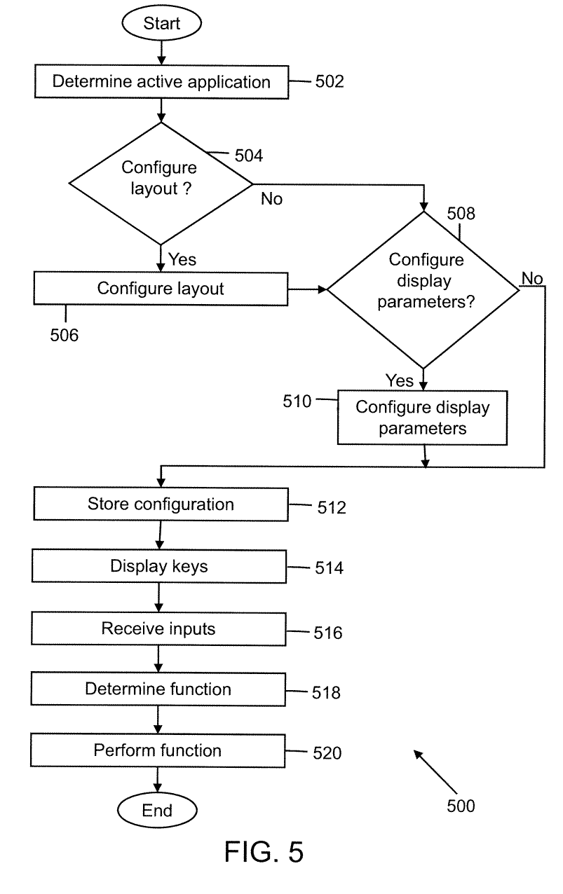

FIG. 5 is a flow diagram illustrating a method for accessing one or more functions corresponding to one or more applications, in accordance with another embodiment of the present invention. The method is illustrated as a collection of steps in a logical flow diagram, which represents a sequence of steps that can be implemented in hardware, software, or a combination thereof. In the context of software, the steps represent computer instructions that, when executed by one or more processors, perform the recited steps.

At step 502, an active application from the applications is determined. In accordance with an embodiment of the present invention, step 502 is performed by application-determining module 306 in FIG. 3. A set of functions corresponding to the active application is also identified.

At step 504, it is checked whether the user wants to configure a layout of a set of keys corresponding to the set of functions. If, at step 504, it is found that the user wants to configure the layout of the set of keys, step 506 is performed. At step 506, the layout of the set of keys is configured as per the user's requirement. The layout may, for example, be a keyboard layout, a list layout or a tabular layout. In accordance with an embodiment of the present invention, steps 504 and 506 are performed by layout-configuration module 310.

Next, at step 508, it is checked whether the user wants to configure one or more display parameters of the set of keys. If, at step 508, it is found that the user wants to configure the display parameters, step 510 is performed. At step 510, the display parameters of the set of keys are configured as per the user's requirements. The display parameters may, for example, include color coding, function coding, icon shapes, icon sizes, fonts, font sizes, key identifiers, grouping, magnetic alignment, background, shadow, opacity, orientation, screen position, appearance time, hiding/unhiding marked shortcuts or animation. In accordance with an embodiment of the present invention, steps 508 and 510 are performed by key-configuration module 312.

At step 512, the layout and the display parameters configured by the user at steps 504-510 are stored. The layout and the display parameters may be stored corresponding to the active application. Alternatively, the layout and the display parameters may be stored for use with all the applications. Thereafter, at step 514, the set of keys corresponding to the set of functions is displayed, in accordance with the layout and the display parameters configured by the user at steps 504-510.

If, at step 508, it is found that the user does not want to configure the display parameters, step 512 is performed. At step 512, the layout configured by the user at steps 504-506 is stored. The layout may be stored corresponding to the active application. Alternatively, the layout may be stored for use with all the applications. Thereafter, at step 514, the set of keys corresponding to the set of functions is displayed, in accordance with the layout configured by the user at steps 504-506.

If, at step 504, it is found that the user does not want to configure the layout of the set of keys, step 508 is performed. If, at step 508, it is found that the user wants to configure the display parameters, step 510 is performed. Next, at step 512, the display parameters configured by the user at steps 508-510 are stored. The display parameters may be stored corresponding to the active application. Alternatively, the display parameters may be stored for use with all the applications. Thereafter, at step 514, the set of keys corresponding to the set of functions is displayed, in accordance with the display parameters configured by the user at steps 508-510.

If, at step 504, it is found that the user does not want to configure the layout of the set of keys, step 508 is performed. If, at step 508, it is found that the user does not want to configure the display parameters, step 514 is performed. In such a case, at step 514, the set of keys corresponding to the set of functions is displayed in a layout previously configured and stored by the user or in a system-defined layout by default.

At step 516, one or more inputs are received from the user. The inputs are based on activation of at least one key from the set of keys. In accordance with an embodiment of the present invention, step 516 is performed by input device 316. Thereafter, at step 518, at least one function from the set of functions is determined corresponding to the activated key. In accordance with an embodiment of the present invention, step 518 is performed by function-determining module 318. Subsequently, at step 520, the function corresponding to the activated key is performed. In accordance with an embodiment of the present invention, step 520 is performed by function-performing module 320.

FIG. 6 illustrates a keyboard layout 600, in accordance with an embodiment of the present invention. Keyboard layout 600 displays keys 602 in a visual, mechanical and functional arrangement. The visual arrangement refers to an arrangement of legends that appear on keys 602 of keyboard layout 600. The mechanical arrangement refers to placements and shapes of keys 602 of keyboard layout 600. The functional arrangement refers to an arrangement of the key-meaning associations of keys 602 of keyboard layout 600. Key-meaning associations of keys are defined as function coding applied on the keys. Keys 602 include a set of keys, such as a key 604, a key 606, a key 608, a key 610, a key 612, a key 614 and so on, displayed on a display panel in keyboard layout 600. Keyboard layout 600 may, for example, include a QWERTY layout, an AZERT layout, a layout showing limited keys, or a shortcut keys layout. Key 604, key 606, key 608 and key 610 represent alphanumeric characters ‘Q’, ‘W’, ‘E’ and ‘R’, respectively, as shown in FIG. 6.

Key 612 includes a plurality of sub-keys such as a sub-key 612a, a sub-key 612b and a sub-key 612c. With reference to FIG. 6, sub-key 612a, sub-key 612b and sub-key 612c represent modifier keys, ‘Ctrl’, ‘Alt’ and ‘Shift’, respectively. When a sub-key is activated, the display of keys 602 is modified in accordance with a modified set of functions corresponding to keys 602. In this way, sub-key 612a, sub-key 612b and sub-key 612c allow the user to preview different sets of functions corresponding to keys 602. For example, in Microsoft® Word application, when sub-key 612a, representing ‘Ctrl’, is activated, the display of keys ‘/’, ‘U’ and ‘B’ is modified to, respectively, represent functions of italicizing, underlining and making bold a selected text.

Key 614 represents a ‘Mode’ key, which allows the user to change the display of keys 602 to match a new set of functions corresponding to a mode in which the user is currently working on an active application. For example, in case of Adobe® Premiere Pro, keyboard layout 600 may be displayed in accordance with a mode of ‘Editing’ by default. The user may activate key 614 to change the display of keys 602 to match different sets of functions corresponding to modes of ‘Titling’ and ‘Capture’. In case of applications that support two modes, key 614 may be used as a toggle key, which toggles between the two modes. In case of applications that support more than two modes, the user may require pressing key 614 a number of times to select a particular mode.

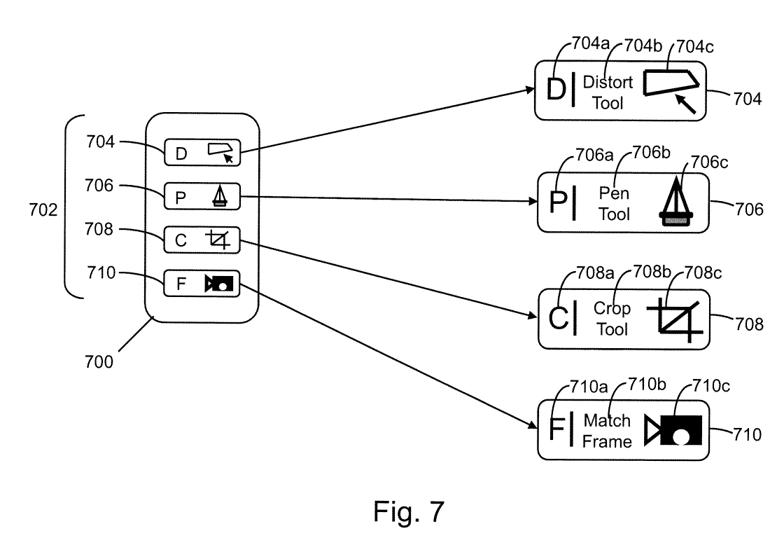

FIG. 7 illustrates a list layout 700, in accordance with an embodiment of the present invention. List layout 700 displays keys 702 in a sequential arrangement. Examples of the sequential arrangement include, but are not limited to, a horizontal arrangement of keys 702 and a vertical arrangement of keys 702. Keys 702 include a set of keys, such as a key 704, a key 706, a key 708 and a key 710, displayed on a display panel in list layout 700.

With reference to FIG. 7, keys 702 correspond to a set of functions of Photoshop application. Key 704, key 706, key 708 and key 710 show their key-identifiers, function codes and icons. The display parameters of keys 702 may change when the user switches from Photoshop application to another application.

Key 704 shows a key-identifier 704a, a function code 704b and an icon 704c. With reference to FIG. 7, key-identifier 704a is an alphanumeric character ‘D’, function code 704b is a function code for ‘Distort Tool’, and icon 704c is an icon representing the function of distorting.

Key 706 shows a key-identifier 706a, a function code 706b and an icon 706c. With reference to FIG. 7, key-identifier 706a is an alphanumeric character ‘P’, function code 706b is a function code for ‘Pen Tool’ and icon 706c is an icon representing the function of removing the background.

Key 708 shows a key-identifier 708a, a function code 708b and an icon 708c. With reference to FIG. 7, key-identifier 708a is an alphanumeric character ‘C’, function code 708b is a function code for ‘Crop Tool’ and icon 708c is an icon representing the function of cropping.

Key 710 shows a key-identifier 710a, a function code 710b and an icon 710c. With reference to FIG. 7, key-identifier 710a is an alphanumeric character ° F., function code 710b is a function code for ‘Match Frame’ and icon 710c is an icon representing the function of finding and loading a frame.

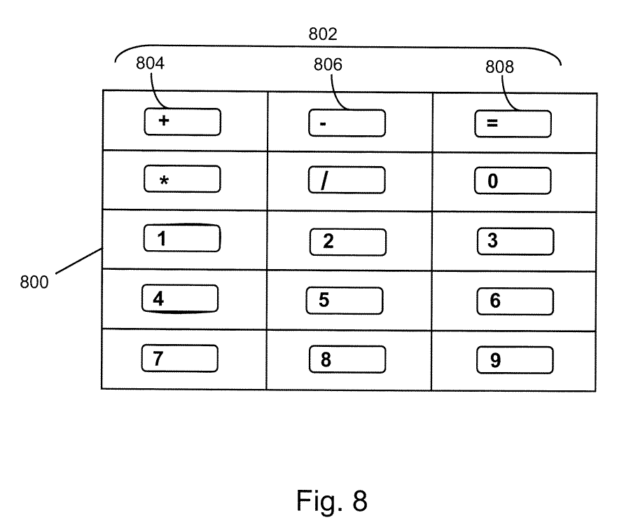

FIG. 8 illustrates a tabular layout 800, in accordance with an embodiment of the present invention. Table layout 800 displays keys 802 in a matrix arrangement. The matrix arrangement refers to a matrix with rows and columns for placing keys 802. The matrix may include a suitable number of rows and columns. In addition, certain rows and/or columns may be left empty. Keys 802 include a set of keys, such as a key 804, a key 806, a key 808 and so on, displayed on a display panel in tabular layout 800.

Key 804, key 806 and key 808 represent computational characters ‘+’, ‘−’, and “=” respectively. With reference to FIG. 8, keys 802 represent a numeric keypad suitable for computing purposes.

Embodiments of the present invention provide a method and system for accessing one or more functions corresponding to one or more applications that is easy to use. When a user switches from an active application to a new active application, it is determined that the user is currently working on the new active application. Accordingly, a new set of functions corresponding to the new active application is identified. Consequently, the display panel automatically displays a new set of keys corresponding to the new set of functions. This makes the shortcut utility easy to use. As described above, the method and system support various applications, and provide mode-specific display of the display panel. In addition, the method and system allow user-customization and multi-user settings.

According to an embodiment of the present invention, the method and system are software-based. Therefore, the method and system can be easily implemented in various languages at low costs. In addition, the layout of the display panel conforms to international keyboard layouts.

This application may disclose several feature limitations that support any range within the disclosed features even though a precise feature limitation is not stated verbatim in the specification because the embodiments of the invention could be practiced throughout the disclosed features. Finally, the entire disclosure of the patents and publications referred in this application, if any, are hereby incorporated herein in entirety by reference.

What is claimed is:

1. A method for accessing one or more functions corresponding to one or more applications, the method comprising:
a) determining an active application from said one or more applications, wherein a set of functions from said one or more functions corresponds to said active application;
b) displaying a set of keys corresponding to said set of functions;
c) receiving one or more inputs, wherein said one or more inputs are based on activation of at least one key from said set of keys;
d) determining at least one function from said set of functions corresponding to said at least one key; and
e) performing said at least one function.

2. The method according to claim 1, wherein said set of keys are displayed in a predefined layout.

3. The method according to claim 2, wherein said predefined layout is selected from the group consisting of a keyboard layout, a tabular layout, and a list layout.

4. The method according to claim 1 further comprising configuring a layout of said set of keys.

5. The method according to claim 1 further comprising configuring one or more display parameters of said set of keys.

6. The method according to claim 5, wherein said one or more display parameters are selected from the group consisting of color coding, function coding, icon shapes, icon sizes, fonts, font sizes, key identifiers, grouping, magnetic alignment, background, shadow, opacity, orientation, screen position, appearance time, hiding/unhiding marked shortcuts and animation.

7. The method according to claim 5 further comprising storing one or more configurations of said one or more display parameters.

8. The method according to claim 1 further comprising determining a mode in which said active application is in, wherein said set of keys are displayed to match a new set of functions corresponding to said mode.

9. The method according to claim 1, wherein said set of functions comprises one or more macros corresponding to said active application.

10. A system for accessing one or more functions corresponding to one or more applications, the system comprising:
a) an application-determining module adapted to determine an active application from said one or more applications, wherein a set of functions from said one or more functions corresponds to said active application;
b) a display panel adapted to display a set of keys corresponding to said set of functions;
c) an input device adapted to receive one or more inputs, wherein said one or more inputs are based on activation of at least one key from said set of keys;
d) a function-determining module adapted to determine at least one function from said set of functions corresponding to said at least one key; and
e) a function-performing module adapted to perform said at least one function.

11. The system according to claim 10, wherein said display panel is displayed in a predefined layout.

12. The system according to claim 11, wherein said predefined layout is selected from the group consisting of a keyboard layout, a tabular layout, and a list layout.

13. The system according to claim 10 further comprising a layout-configuration module adapted to configure a layout of said display panel.

14. The system according to claim 10 further comprising a key-configuration module adapted to configure one or more display parameters of said set of keys.

15. The system according to claim 14, wherein said one or more display parameters are selected from the group consisting of color coding, function coding, icon shapes, icon sizes, fonts, font sizes, key identifiers, grouping, magnetic alignment, background, shadow, opacity, orientation, screen position, appearance time, hiding/unhiding marked shortcuts and animation.

16. The system according to claim 14 further comprising a storing module adapted to store one or more configurations of said one or more display parameters.

17. The system according to claim 10, wherein said input device is selected from the group consisting of a mouse, a touch-sensitive screen, a keyboard, a trackball, a touchpad, a joystick, a pointing stick, and a graphics tablet with a pen.

18. The system according to claim 10 further comprising a mode-determining module adapted to determine a mode in which said active application is in, wherein said display panel displays said set of keys to match a new set of functions corresponding to said mode.

19. The system according to claim 10 further comprising a macro module adapted to execute one or more macros corresponding to said active application.

20. A computer program product for use with a computer, the computer program product comprising a computer-usable medium having a computer-readable program code embodied therein for accessing one or more functions corresponding to one or more applications, the computer-readable program code performing the steps of:
a) determining an active application from said one or more applications, wherein a set of functions from said one or more functions corresponds to said active application;
b) displaying a set of keys corresponding to said set of functions;
c) receiving one or more inputs, wherein said one or more inputs are based on activation of at least one key from said set of keys;
d) determining at least one function from said set of functions corresponding to said at least one key; and
e) performing said at least one function.

21. The computer program product according to claim 20, wherein said set of keys are displayed in a predefined layout.

22. The computer program product according to claim 21, wherein said predefined layout is selected from the group consisting of a keyboard layout, a tabular layout, and a list layout.

23. The computer program product according to claim 20, wherein the computer-readable program code further performs the step of configuring a layout of said set of keys.

24. The computer program product according to claim 20, wherein the computer-readable program code further performs the step of configuring one or more display parameters of said set of keys.

25. The computer program product according to claim 24, wherein said one or more display parameters are selected from the group consisting of color coding, function coding, icon shapes, icon sizes, fonts, font sizes, key identifiers, grouping, magnetic alignment, background, shadow, opacity, orientation, screen position, appearance time, hiding/unhiding marked shortcuts and animation.

26. The computer program product according to claim 24, wherein the computer-readable program code further performs the step of storing one or more configurations of said one or more display parameters.

27. The computer program product according to claim 20, wherein the computer-readable program code further performs the step of executing one or more macros corresponding to said active application.

28. The computer program product according to claim 20, wherein the computer-readable program code further performs the step of determining a mode in which said active application is in, wherein said set of keys are displayed to match a new set of functions corresponding to said mode.
